(19) United States
(12) Patent Application Publication
(10) Pub. No.: US 2020/0170337 A1
(43) Pub. Date: Jun. 4, 2020

(54) THREE LAYER SHOE CONSTRUCTION WITH IMPROVED CUSHIONING, FLEXIBILITY, AND SHOCK ABSORPTION

(71) Applicant: Footwear Unlimited Inc., Fenton, MO (US)

(72) Inventor: Fabio Lucca, Valley Park, MO (US)

(21) Appl. No.: 16/205,378

(22) Filed: Nov. 30, 2018

(51) Int. Cl. A43B 13/12; A43B 7/00; A43B 1/00; A43B 13/04; A43B 7/32; A43B 17/14; A43B 13/16; A43B 7/14; B32B 3/26; B32B 25/08; B32B 27/08; B32B 27/30

(52) U.S. Cl. CPC A43B 13/125; B32B 2437/02; A43B 1/0045; A43B 13/04; A43B 7/32; A43B 13/122; A43B 17/14; A43B 13/16; A43B 7/142; A43B 7/143; B32B 3/266; B32B 3/263; B32B 25/08; B32B 27/08; B32B 27/306; A43B 7/00

(57) ABSTRACT

A three-layered shoe construction including an outsole having a shoulder portion and a plurality of two different types of grooves, one set of grooves being wave-like channels and one set of grooves being substantially straight, the grooves creating flow channels to guide liquid off the outer surface of the outsole and providing additional flexibility; a dual density midsole having an angled portion and a first density in the forefoot area and a second density in the hind foot area, the second density being greater than the first density, the angled portion of the midsole mating with the shoulder portion of the outsole; and an insole having a plurality of apertures that cover the top face. The specific construction associated with the outsole, midsole and insole enhance traction, flexibility, cushioning, comfort, breathability and water displacement.

### FIELD OF THE INVENTION

The present invention relates to a shoe construction and, more particularly, to a three layered shoe construction with an outsole having a unique exterior face pattern to enhance flexibility, comfort, stability and water displacement, a dual density midsole, and an insole having a Y-shaped aperture pattern for increased breathability, air circulation, and comfort coupled with a raised arch area for providing additional support to the arch of the foot.

### BACKGROUND OF THE INVENTION

Numerous shoes, covering a broad range of different designs and styles have been manufactured and sold in the marketplace. While shoes are worn to provide protection to one's feet, to reduce the impact felt when walking on hard surfaces, to provide support for the feet, and to prevent pronation, shoe designers must still seek to provide optimum levels of stability and comfort. In order to accomplish all of these objectives, shoe designers have used a wide variety of different tools and methods including heel plugs, shanks, contoured soles, deformable pillars or columns, spring-like structures, different traction designs, cushioning members, different shank designs, different ventilation structures, rocker elements, pads, gels and sole constructions having a plurality of different layers. Although these methods can be effective, the large number of components can result in increased manufacturing costs and complexity. It is therefore desirable to improve cushioning, flexibility, support and stability without increasing the number of components to achieve the same level of comfort for the user.

### SUMMARY OF THE INVENTION

The present invention is directed to a three layer shoe construction which includes an outsole, midsole, and insole. The three layers have a mating relationship which will be later described in detail. The three components of the present shoe are preferably secured together through conventional means such as through cementing and/or adhesives thereby preventing relative movement between the layers during assembly and use of the present shoe. Each of the three layers of the present shoe are generally in the shape of a human foot and can be divided into different sections according to the three different regions of the human foot—the forefoot, the midfoot, and the hind foot. The forefoot is generally adjacent to and includes the toe area; the hind foot is generally adjacent to and includes the heel area; and the midfoot is located adjacent to both the forefoot and the hind foot. The ball of the foot is generally the area of the foot at the juncture between the metatarsal bones and the phalange bones. The two primary regions of the foot for load bearing when walking or standing normally are the ball area and the heel area, and the major bending of the shoe during normal use is typically in the ball area. The arch or instep is positioned between the heel and ball areas and flexes very little when walking normally.

The present outsole is made out of a super lightweight thermoplastic rubber (TPR) and includes an exterior and interior face. The exterior face of the present outsole engages the ground or other walking surfaces, while the interior face is located opposite the exterior face and has a mating relationship with the midsole as will be hereinafter further described in more detail.

The exterior face of the outsole includes a first section, a second section, and a third section located and positioned at approximately the forefoot, midfoot, and hind foot areas respectively. The first section includes the forefoot area and extends partly into the midfoot area. In one embodiment, the first section extends into the midfoot area on the lateral side. The first section further includes a plurality of wave-like channels forming a plurality of wave-like ridges, each wave-like ridge including a plurality of straight grooves to provide a non-slid surface, extra flexibility and comfort in the first section and improved water displacement in inclement weather. The first section is divided from the second section by a wave-like channel. The second section, on the other hand, includes the majority of the midfoot area and is largely smooth. The third section includes the hind foot area and also extends into the midfoot area on the medial side. The third section includes a shoulder portion which extends and curves upwardly in the hind foot area away from the ground or other supporting surface towards the midsole. Like the first section, the third section also includes a plurality of wave-like channels forming a plurality of wave-like ridges, each wave-like ridge also including a plurality of straight grooves to provide a non-slid surface, extra flexibility and comfort, and improved water displacement. The third section of the outsole is divided from the second section by a wave-like channel. The interior face of the outsole is substantially smooth.

The midsole is made of a dual density blown ethylene-vinyl acetate copolymer (EVA) with an intrinsic molded raised arch support area which supports the arch of the foot. The EVA creates a lightweight and resilient midsole, which helps dissipate shock when walking or running. In addition to the material itself, the dual density of the midsole allows for a greater flexibility and cushioning in the forefoot area due to its lighter density, and provides greater support and stability in the hind foot area due to its heavier density. The sidewall of the midsole extends completely around the perimeter of the midsole is preferably smooth. Like the outsole, the hind foot area of the midsole includes an angled portion which curves upwards away from the outsole.

The midsole includes a proximal and a distal face. The distal face of the midsole includes a plurality of grooves located and positioned in the forefoot area which provide additional flexibility at the ball area of the foot, allowing the midsole to flex more easily when the wearer walks. The midsole has a mating relationship with the outsole, where the angled portion of the midsole aligns and mates with the shoulder portion of the outsole. The mating of the angled portion of the midsole with the shoulder portion of the outsole provides shock absorption and reduces the impact felt when walking and further propels the weight of the wearer forward in a rolling motion across the sole of the shoe.

The proximal face of the midsole includes a ledge or flange that extends around the entire circumference of the midsole thereby creating a first cavity substantially in the shape of the midsole. The insole mates with and is received by the cavity created by the ledge on the proximal face. The proximal face of the midsole further includes a ridge located on the upper surface of the ledge, the ridge extending around the entire circumference of the midsole creating a second cavity in the midsole between the perimeter of the insole and the ridge when the insole is inserted into the first cavity of the midsole. The three layers are preferably secured together to prevent movement when worn.

The insole is a lightweight, thermal molded EVA with an antimicrobial shield which provides protection against bacteria, fungus, and controls or eliminates odors, stains, and product deterioration. This can be accomplished by adding a powder or other antimicrobial agents during the manufacturing process. The insole has a top face and a bottom face, the top face engaging with the foot of a wearer and includes a plurality of Y-shaped apertures that provide both greater flexibility and breathability when the overall shoe is worn.

The present three layer shoe construction absorbs shock, enhances comfort, and creates a unique propulsion effect, without requiring a vast number of components.

### BRIEF DESCRIPTION OF THE DRAWINGS

For a better understanding of the various embodiments of the present invention, reference may be made to the accompanying drawings in which:

FIG. 1 is an exploded perspective view illustrating a shoe structure constructed according to the teachings of the present invention;

FIG. 2 is a side elevational view of the outsole of FIG. 1;

FIG. 3 is a bottom plan view of the outsole of FIGS. 1 and 2;

FIG. 4. is a top plan view of the outsole of FIGS. 1, 2, and 3;

FIG. 5 is a side elevational view of a midsole of FIG. 1;

FIG. 6 is a bottom plan view of the midsole of FIGS. 1 and 5;

FIG. 7 is a bottom plan view of the outsole and midsole of FIGS. 1-6 mated together;

FIG. 8 is a side elevational view of the outsole and midsole of FIG. 7;

FIG. 9 is a top plan view of the midsole of FIGS. 1 and 5-8;

FIG. 10 is a top plan view of the midsole and an insole of FIG. 1 mated together;

FIG. 11 is a side elevational view of the insole of FIGS. 1 and 10;

FIG. 12 is a top plan view of the insole of FIGS. 1, 10, and 11; and

FIG. 13 is a bottom plan view of the insole of FIGS. 1 and 10-12.

While the disclosure is susceptible to various modifications and alternative forms, specific embodiments thereof are shown by way of example in the drawings and will hereafter be described in detail. It should be understood, however, that the drawings and detailed description presented herein are not intended to limit the disclosure of the present invention to the particular embodiment disclosed, but on the contrary, the intention is to cover all modifications, equivalents, and alternatives falling within the spirit and scope of the present disclosure.

### DETAILED DESCRIPTION OF THE DRAWINGS

The present invention will now be described with reference to the drawing figures in which like reference numerals refer to like parts throughout the disclosure. For purposes of clarity in illustrating the characteristics of the present invention, proportional relationships of the elements have not necessarily been maintained in the drawing figures.

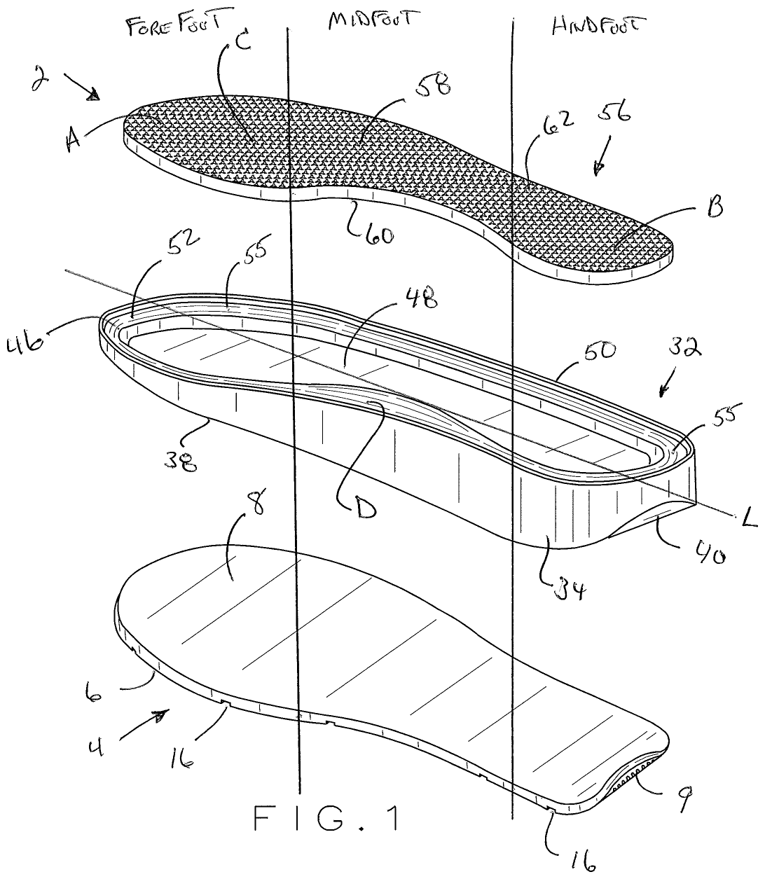

As illustrated in FIG. 1, a three layer shoe construction 2 constructed in accordance with the teachings of the present invention includes an outsole 4, a midsole 32, and an insole 56. The outsole 4, midsole 32, and insole 56 have a mating relationship to each other as will be hereinafter further described. The combination of the three layers produces flexibility and shock absorption, as well as a unique cushioning and bouncing propulsion effect allowing the wearer to walk more easily. The layers of the present shoe are preferably secured together in a conventional manner such as through cementing and/or adhesives thereby preventing relative movement between the layers during assembly and use of the present shoe.

Each of the three layers of the present shoe are generally in the shape of a human foot and can be divided into different sections according to three distinct regions of the human foot—the forefoot, midfoot, and hind foot. The forefoot area or region of the foot is approximately adjacent to and includes the toe area A, while the hind foot area or region of the foot is approximately adjacent to and includes the heel area B. The midfoot area or region is approximately adjacent to both the forefoot and hind foot regions as illustrated in FIG. 1 and includes the arch area D. The ball area C of the foot is generally the area of the foot at the juncture between the metatarsal bones and the phalange bones. The two primary regions of the foot for load bearing when walking or standing normally includes the ball area C and the heel area B, and the major bending of the shoe during normal use is typically in the vicinity of the ball area C. The arch or instep area D is located between the heel area B and ball area C, and flexes very little when walking normally. The three layers of the present shoe also include a longitudinal axis L, which extends through the forefoot, midfoot and hind foot, and can further be divided into a medial and lateral half. The medial half is located on the side of the longitudinal axis that includes the arch area D, while the lateral half is located on the other side of the longitudinal axis.

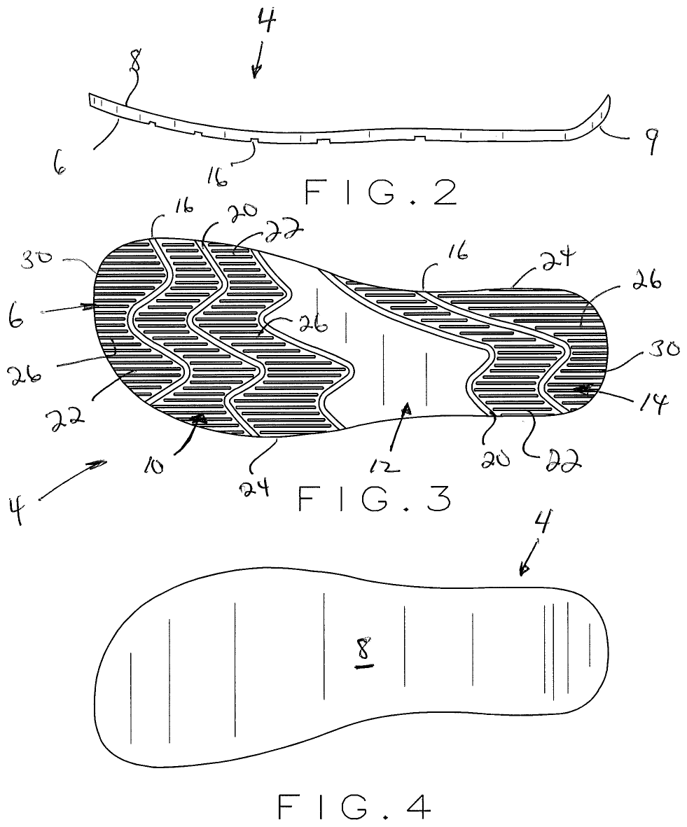

The present outsole 4 is made out of a super lightweight thermoplastic rubber (TPR) and includes an exterior face 6 and an interior face 8 as seen in FIG. 2. The exterior face 6 of the outsole 4 engages with the ground or other walking surfaces, while the interior face 8 has a mating relationship with the midsole 32 as will be hereinafter described in more detail. The outsole 4 further includes an upwardly extending shoulder portion 9 located and positioned at the heel area B. The shoulder portion 9 of the outsole 4 slopes upwards at a gradual angle, away from the ground or other supporting surface and towards the midsole 32. In other words, when the outsole 4 is placed with the exterior face 6 engaging the ground or other support surface, the shoulder portion 9 does not engage or touch the ground or other supporting surface. The remainder of the outsole 4 is preferably substantially planar and does not curve or slope. However, in alternative embodiments, the toe area A of the outsole 4 may also slope upwards.

In one embodiment, the exterior face 6 of the outsole 4 includes a first section 10, a second section 12, and a third section 14, divided approximately into the forefoot, midfoot, and hind foot areas respectively as best illustrated in FIGS. 3 and 7. The first section 10 includes the forefoot area and extends into the midfoot area on the lateral side of the outsole 4. The second section 12, on the other hand, includes the majority of the midfoot area. Finally, the third section 14 largely includes the hind foot area and also extends into the midfoot area on the medial side of the outsole 4, substantially adjacent to the arch area D.

The first section 10 and third section 14 include a plurality of wave-like channels 16 which extend from the medial side to the lateral side of the outsole 4, with each channel having at least one wave or curve associated therewith. Each channel 16 may be shaped different from another channel 16. Each channel 16 forms non-linear ridges 22 between an adjacent channel 16 and each channel 16 is defined by a pair opposing sidewalls (not shown) and a bottom surface 20 in a second plane. The bottom surface 20 and the pair of opposing sidewalls create a fluid flow channel 16 to guide liquid off of the outer surface of the ridges 22 to the outer perimeter 24 of the outsole 4, thereby preventing the outer surface 22 from being slippery. The channels 16 also provide extra flexibility and comfort to the wearer when the present shoe is worn.

In addition to the channels 16, the plurality of ridges 22 of the first section 10 and third section 14 further include a plurality of straight grooves 26 that extend longitudinally, located and positioned on either one or both sides of the channels 16, on the ridges 22. Both the number of grooves 26 and spacing between each straight groove 26 may vary as each groove 26 extends substantially in a direction along the longitudinal axis of the outsole in between the perimeter 24 of the outsole and the wave-like channel 16 or in between two wave-like channels 16 as best illustrated in FIG. 3. Similar to the plurality of wave-like channels 16, the straight grooves 26 also create fluid flow channels which are defined by a pair opposing sidewalls (not shown) and a bottom surface 30 in a second plane. The grooves 26 also guide liquid off of the outer ridge surfaces 22 to the outer perimeter 24 of the outsole 4, or to a channel 16, thereby also preventing the outer ridge surfaces 22 from becoming slippery. The second section 12 of the outsole 4 is substantially smooth. The interior face 8 of the outsole 4 is substantially smooth as seen in FIG. 4.

The midsole 32 is made of a dual density blown ethylene-vinyl acetate copolymer (EVA) with an intrinsic molded raised arch support area 33 which supports the arch area D of the foot, reinforcing the arch in its proper position, which is best shown in FIG. 9. The EVA creates a lightweight and resilient midsole 32 which helps dissipate shock when walking or running. In addition to the material itself, the dual density of the midsole 32 allows for a greater flexibility and cushioning in the forefoot area due to its lighter density, and provides greater support and stability in the hind foot area due to its heavier density. In simple terms, the forefoot area C of the present midsole 32 has a lighter density as compared to a heavier density heel area B.

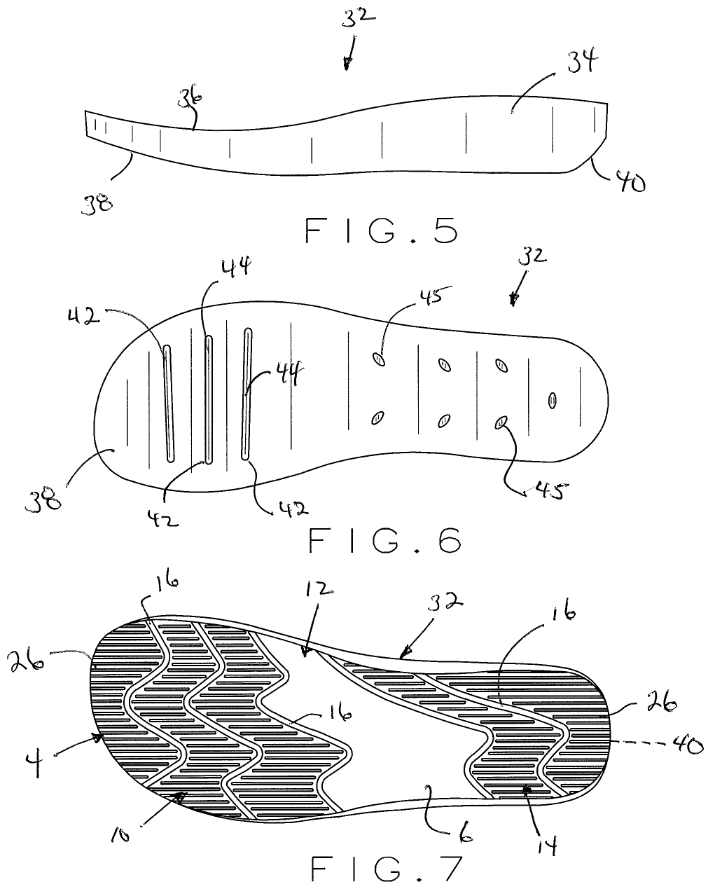

The sidewall 34 of the midsole 32 extends completely around the perimeter of the midsole 32 and is substantially smooth as best illustrated in FIG. 5. The midsole 32 includes both a proximal face 36 and a distal face 38, the proximal face 36 having a mating relationship with the insole 56 and the distal face 38 having a mating relationship with the outsole 4. The distal face 38 further includes an angled portion 40 located and positioned at the heel area B. The angled portion 40 gradually slopes upwards from the distal face 38 towards the proximal face 36 so that the sidewall 34 forms or slopes at an angle to the distal face 38. The sidewall 34 preferably abuts the proximal face 36 at a substantially perpendicular angle. In alternative embodiments, the intersection of the sidewall 34 and distal face 38 (or the intersection of the sidewall 34 and the proximal face 36) may be at different angles.

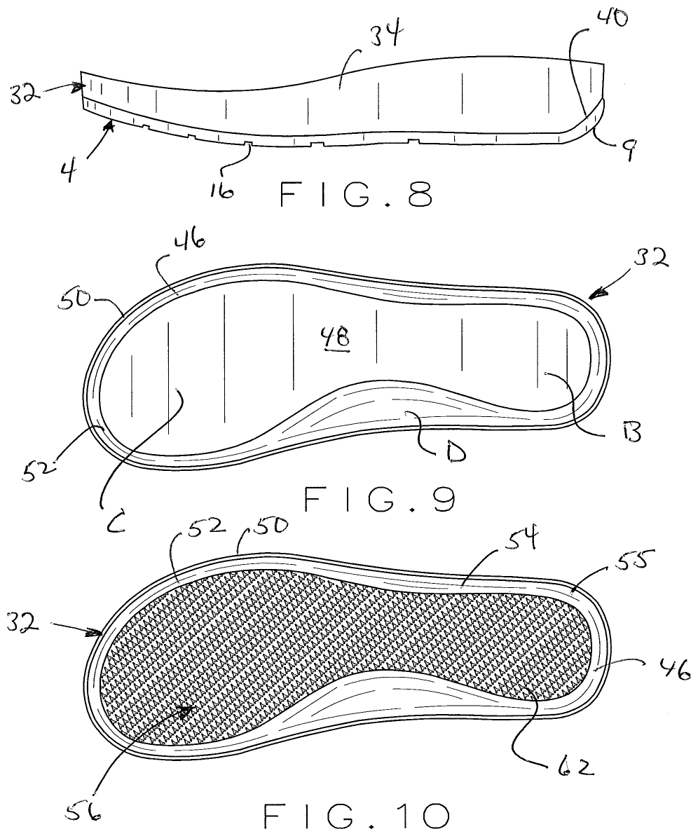

Referring to FIG. 6, the distal face 38 of the midsole 32 includes a plurality of grooves 42 that extend substantially horizontally across the forefoot area, from the medial side to the lateral side of the midsole 32. The plurality of grooves 42 are defined by a pair of sidewalls (not shown) and a bottom surface 44 in a second plane. The plurality of grooves 42 provides additional flexibility at the ball area C of the foot, allowing the midsole 32 to more easily flex when the wearer walks. They also provide increased comfort. The distal face 38 of the midsole 32 may further include a plurality of apertures 45 located and positioned at the midfoot area and/or the hind foot area in some embodiments, which serve to decrease the weight of the midsole 32 and also provide some flexibility in those areas. The midsole 32 is substantially in the shape of the outsole 4 and has a mating relationship with the outsole 4. The angled portion 40 of the midsole 32 aligns and mates with the shoulder portion 9 of the outsole 4. Thus, when the angled portion 40 mates with the shoulder portion 9, the shoulder portion 9 substantially cups and surrounds the angled portion 40 as best illustrated in FIGS. 7 and 8. The combination of the shoulder portion 9 of the outsole 4 and the angled portion 40 of the midsole 32 provides shock absorption and reduces the impact felt when walking and further propels the weight of the wearer forward in a rolling motion across the sole of the shoe.

The insole 56 also has a mating relationship to the midsole 32 wherein the proximal face 36 of the midsole 32 has a ledge or flange 46 extending around its entire circumference creating a cavity 48 substantially in the shape of the insole 56 as shown in FIG. 9. The insole 56 mates with and is received by the cavity 48 created by the ledge 46 on the proximal face 36 of the midsole 32 as illustrated in FIG. 10. In some embodiments, the proximal face 36 further includes a ridge or flange 50 located and positioned on the upper surface 52 of the ledge 46 shown in FIGS. 9 and 10, the flange 50 extending above and entirely around the perimeter of the ledge 46. The ridge 50 extends upwards from the ledge 46 and forms part of the midsole sidewall 34. The ridge 50 and ledge 46 form a perimeter channel 55 around the perimeter of the midsole. When the insole 46 is received within the midsole cavity 48, the perimeter of the insole 56 lies slightly above the top surface 52 of the ledge 46 thereby forming a second cavity 54 in the midsole, or a valley, in between the ridge 50 and the perimeter of insole 56 as best shown in FIG. 10. The bottom surface of the second cavity 54 is the upper surface 52 of the ledge 46. Leather, cloth, and other upper materials may be placed within the second cavity or valley 54, or the perimeter channel 55, for decorative purposes. The three layers are preferably secured together by cementing and/or adhesives thereby preventing relative movement between the layers during assembly and use of the present shoe.

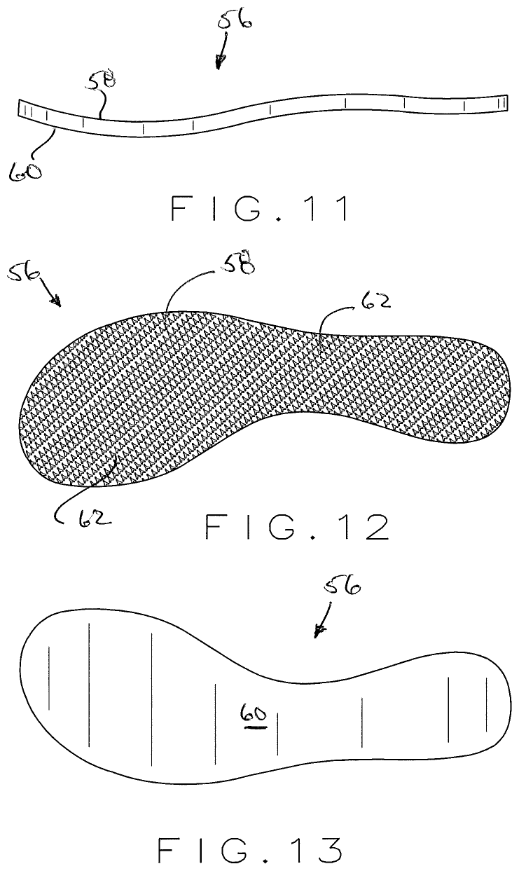

The insole 56 is a lightweight, thermal molded EVA with an antimicrobial shield which provides protection against bacteria, fungus, and controls or eliminates odors, stains, and product deterioration. This can be accomplished by adding a powder or other antimicrobial agents during the manufacturing process. The insole 56 has a top face 58 and a bottom face 60 as best illustrated in FIG. 11. Turning to FIG. 12, the top face 58 engages with the foot of a wearer and includes a plurality of apertures 62 that provides both greater flexibility and breathability when worn. In one embodiment, the plurality of apertures 62 are Y shaped, and cover the top face 58 of the insole 56. The combination of the outsole 4, midsole 32, and insole 56 allows for great shock absorption, cushioning, flexibility and also produces a unique bouncing propulsion effect. The bottom face 60 is substantially smooth and is received by the cavity 48 of the midsole 32 as best illustrated in FIG. 13. The grooves or channels 16 and 26 on the exterior face 6 of the outsole also provide for improved water displacement.

From the foregoing, it will be seen that the various embodiments of the present invention are well adapted to attain all the objectives and advantages hereinabove set forth together with still other advantages which are obvious and which are inherent to the present structures. It will be understood that certain features and sub-combinations of the present embodiments are of utility and may be employed without reference to other features and sub-combinations. Since many possible embodiments of the present invention may be made without departing from the spirit and scope of the present invention, it is also to be understood that all disclosures herein set forth or illustrated in the accompanying drawings are to be interpreted as illustrative only and not limiting. The various constructions described above and illustrated in the drawings are presented by way of example only and are not intended to limit the concepts, principles and scope of the present invention.

Many changes, modifications, variations and other uses and applications of the present invention will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A shoe construction comprising:
an outsole having an outer perimeter, an exterior face, an interior face, a medial side, a lateral side, a forefoot area, a midfoot area, a hind foot area, and a shoulder portion, the exterior face including a first section located in the vicinity of the forefoot area, a second section located in the vicinity of the midfoot area, and a third section located in the vicinity of the hind foot area, the first section extending from the forefoot area to the lateral side of the midfoot area, the third section extending from the hind foot area to the medial side of the midfoot area, each of the first and third sections including a plurality of wave-like channels forming a plurality of non-linear ridges, each non-linear ridge including a plurality of straight grooves, the wave-like channels extending across the first and third sections from the outer perimeter on the medial side to the outer perimeter on the lateral side, and the straight grooves extending in a direction along a longitudinal axis of the outsole;
a midsole having a proximal face, a distal face, a medial side, a lateral side, an outer perimeter, a forefoot area, a midfoot area, a hind foot area, and an angled portion, the midsole having a first density in the forefoot area and a second density in the hind foot area, the distal face of the midsole having a plurality of grooves in the forefoot area, the plurality of grooves extending from the lateral side towards the medial side, the midsole having a first cavity located and positioned on its proximal face; and
an insole having a top face and a bottom face, the top face of the insole including a plurality of apertures;
the distal face of the midsole being shaped and dimensioned to mate with the outsole, the angled portion of the midsole being shaped and dimensioned to mate with the shoulder portion of the outsole, and the first cavity on the proximal face of the midsole being shaped and dimensioned to receive the insole.

2. The shoe construction of claim 1 wherein the midsole includes a ridge forming a second cavity located between a perimeter of the insole and the ridge when the insole is received within the first cavity.

3. The shoe construction of claim 1 wherein the outsole is made of a super lightweight thermoplastic rubber.

4. The shoe construction of claim 1 wherein the midsole is made of an ethylene-vinyl acetate copolymer.

5. The shoe construction of claim 1 wherein the midsole includes a sidewall extending completely around the perimeter of the midsole, the sidewall being substantially smooth.

6. The shoe construction of claim 1 wherein the insole is made of a lightweight thermal molded EVA.

7. The shoe construction of claim 1 wherein the distal face of the midsole further includes a plurality of apertures located and positioned at the hind foot area.

8. The shoe construction of claim 1 wherein the plurality of apertures of the insole are Y-shaped in configuration.

9. A three layered shoe construction comprising:
an outsole having an outer perimeter, an exterior face, an interior face, a medial side, a lateral side, a forefoot area, a midfoot area, a hind foot area, and an upwardly extending shoulder portion, the exterior face including a first section located in the vicinity of the forefoot area, a second section located in the vicinity of the midfoot area, and a third section located in the vicinity of the hind foot area, the first section extending from the forefoot area to the lateral side of the midfoot area, the third section extending from the hind foot area to the medial side of the midfoot area, each of the first and third sections including a plurality of wave-like channels and a plurality of non-linear ridges, the wave-like channels extending across the first and third sections from the outer perimeter on medial side to the outer perimeter on the lateral side, the non-linear ridges in the first and third sections including a plurality of straight grooves each extending in a direction along the longitudinal axis of the outsole;
a midsole having a proximal face, a distal face, a medial side, a lateral side, an outer perimeter, a forefoot area, a midfoot area, a hind foot area, and an angled portion associated with the hind foot area, the midsole having a first density in the forefoot area and a second density in the hind foot area, the distal face of the midsole having a plurality of grooves in the forefoot area which extend from the lateral side towards the medial side and a plurality of apertures located and positioned in both the midfoot and hind foot areas, the midsole having a first cavity located and positioned on its proximal face; and
an insole having a top face and a bottom face, the top face of the insole including a plurality of Y-shaped apertures;
the distal face of the midsole being shaped and dimensioned to mate with the outsole, the angled portion of the midsole being shaped and dimensioned to mate with the shoulder portion of the outsole, and the first cavity on the proximal face of the midsole being shaped and dimensioned to receive the insole.

10. The shoe construction of claim 9 wherein the outsole is made of a super lightweight thermoplastic rubber.

11. The shoe construction of claim 9 wherein the midsole is made of an ethylene-vinyl acetate copolymer.

12. The shoe construction of claim 9 wherein the insole is made of a lightweight thermal molded EVA.

13. The shoe construction of claim 9 wherein the midsole includes a sidewall extending completely around the perimeter of the midsole, the sidewall being substantially smooth.

14. The shoe construction of claim 9 wherein the second section of the outsole is substantially smooth.

15. A three layered shoe construction comprising:
an outsole having an outer perimeter, an exterior face, an interior face, a medial side, a lateral side, a forefoot area, a midfoot area, a hind foot area, and a shoulder portion extending upwardly from the hind foot area, the exterior face including a first section located in the vicinity of the forefoot area, a second section located in the vicinity of the midfoot area, and a third section located in the vicinity of the hind foot area, the first section extending from the forefoot area to the lateral side of the midfoot area, the third section extending from the hind foot area to the medial side of the midfoot area, each of the first and third sections including a plurality of wave-like channels and a plurality of straight grooves, the wave-like channels extending across the first and third sections from the outer perimeter on medial side to the outer perimeter on the lateral side and the straight grooves extending in a direction along the longitudinal axis in between the outer perimeter and the wave-like channels of the first and third sections;
a midsole having a proximal face, a distal face, a medial side, a lateral side, an outer perimeter, a forefoot area, a midfoot area, a hind foot area, and an angled portion extending upwardly from the distal face in the hind foot area, the midsole having a first density in the forefoot area and a second density in the hind foot area, the first density being less than the second density, the distal face of the midsole having a plurality of grooves in the forefoot area, extending from the lateral side towards the medial side, the midsole including a sidewall extending completely around the perimeter of the midsole, said sidewall forming a ridge around the perimeter of the midsole, a ledge extending adjacent to said ridge around the perimeter of the midsole, the midsole having a first cavity located and positioned on its proximal face formed by said ledge; and
an insole having a top face and a bottom face, the top face of the insole including a plurality of apertures;
the distal face of the midsole being shaped and dimensioned to mate with the outsole, the angled portion of the midsole being shaped and dimensioned to mate with the shoulder portion of the outsole, and the first cavity on the proximal face of the midsole being shaped and dimensioned to receive the insole, the perimeter of the insole, said ledge and said ridge forming a perimeter channel on the proximal face of the midsole.

16. The shoe construction of claim 15 wherein the plurality of apertures on the top face of the insole are Y-shaped in configuration.

17. The shoe construction of claim 15 wherein the insole includes an antimicrobial shield.
